(19) United States
(12) Patent Application Publication
(10) Pub. No.: US 2023/0342205 A1
(43) Pub. Date: Oct. 26, 2023

(54) MULTI-PROCESSING ACCELERATING METHOD AND SYSTEM BASED ON ELECTRONIC-SYSTEM-LEVEL VIRTUAL PLATFORM

(71) Applicant: MONTAGE TECHNOLOGY CO., LTD., Shanghai (CN)

(72) Inventor: Yu CAI, Shanghai (CN)

(73) Assignee: MONTAGE TECHNOLOGY CO., LTD., Shanghai (CN)

(21) Appl. No.: 18/129,098

(22) Filed: Mar. 31, 2023

(30) Foreign Application Priority Data
Apr. 25, 2022 (CN) 2022104433868

(51) Int. Cl. G06F 9/50; G06F 9/54

(52) U.S. Cl. CPC G06F 9/5027; G06F 9/547

(57) ABSTRACT

A multi-processing accelerating method and a multi-processing accelerating system based on an electronic-system-level virtual platform are provided. The method includes: creating a controller domain and a plurality of client domains on the electronic-system-level virtual platform, each client domain corresponds to a process; and controlling, by the controller domain, the client domains in parallel to enable multi-processing for the client domains. The multi-processing accelerating method and the system for the electronic-system-level virtual platform can effectively accelerate the operation of the electronic-system-level virtual platform and improve the efficiency of software development of the electronic-system-level virtual platform.

### CROSS REFERENCE TO RELATED APPLICATION

This application claims the benefits of priority to Chinese Patent Application No. CN 202210443386.8, entitled “Multi-Processing Accelerating Method and System Based on Electronic-System-Level Virtual Platform”, filed with CNIPA on Apr. 25, 2022, the content of which is incorporated herein by reference in its entirety.

### FIELD OF TECHNOLOGY

The present disclosure relates to the field of software platforms, and more specifically, to a multi-processing accelerating method and a multi-processing accelerating system based on an electronic-system-level virtual platform.

### BACKGROUND

In the prior art, electronic-system-level (ESL) modeling methods typically adopt SystemC to create hardware models and build virtual platforms (hereinafter, ESL virtual platforms) for both hardware verification and software development. Discrete event simulation (DES) kernels of the SystemC generate a hardware parallel execution abstraction according to a single thread kernel named quick thread. However, since the quick thread is single-threaded, all models run sequentially. This causes the ESL virtual platforms to run very slowly, which affects the efficiency of software development and debugging.

The ESL virtual platforms can be accelerated by the following two methods: (1) modifying multi-threaded kernels of the SystemC; and (2) analyzing dependencies. However, the above two methods are required to follow a specific modeling coding style, and thus have limitations in certain application scenarios and often require modifications to the existing models.

### SUMMARY

The present disclosure provides a multi-processing accelerating method based on an electronic-system-level virtual platform. The multi-processing accelerating method includes: creating a controller domain and a plurality of client domains on the electronic-system-level virtual platform, wherein each client domain corresponds to a progress; and controlling, by the controller domain, the client domains in parallel to enable multi-processing for the client domains.

In an embodiment, each client domain includes a client and SystemC intellectual property models, wherein each client is used to communicate with the controller domain.

In an embodiment, the controller domain is communicated with each client domain through a corresponding unix domain socket.

In an embodiment, the client domains are communicated with each other through a corresponding unix domain socket.

In an embodiment, processes where the client domains are communicated with each other through a corresponding unix domain socket include: setting two of the client domains communicated with each other to be a master module domain and a slave module domain respectively, wherein the master module domain includes a master module and a remote initiator proxy, the slave module domain includes a slave module and a remote target proxy; encoding and serializing, by the master model, transaction-level-modeling (TLM) messages into messages in a predefined message format, and transmitting the messages in the predefined message format to the remote initiator proxy; transmitting, by the remote initiator proxy, the messages in the predefined message format to the remote target proxy through a corresponding unix domain socket; deserializing and decoding, by the remote target proxy, the messages in the predefined message format to obtain the TLM messages, and transmitting the TLM messages to the slave module; and receiving, by the slave module, the TLM messages.

In an embodiment, the master module and the salve module are implemented by SystemC intellectual property models of corresponding client domains respectively, and the remote initiator proxy and the remote target proxy are implemented by client instances of corresponding client domains respectively.

In an embodiment, steps of controlling the client domains in parallel to enable multi-processing for the client domains include: during initialization, parsing, by the controller domain, a configuration file to determine SystemC intellectual property modules included in each client domain, starting a unix domain socket server, and waiting for the client domains to connect to the unit domain socket server; during modularization, instantiating, by each client domain, its own instances of SystemC intellectual property modules and recording its own initiator transaction-level-modeling (TLM) sockets or its own target TLM sockets; during start-up, creating, by each client domain, its own remote initiator sockets or its own remote target sockets, and establishing connections among the client domains based on a confirmation message from the controller domain; and starting, by each client domain, its own SystemC kernels when all the client domains receive a barrier message from the controller domain; and during operation, when any client domain transmits an end message to the controller domain, broadcasting, by the controller domain, the end message to the other client domains to stop the operation of all the client domains and end the operation of the controller domain.

The present disclosure provides a multi-processing accelerating system based on an electronic-system-level virtual platform. The multi-processing accelerating system includes: a plurality of client domains, created on the electronic-system-level virtual platform, wherein each client domain corresponds to a process; and a controller domain, created on the electronic-system-level virtual platform, used to control the client domains in parallel to enable multi-processing for the client domains.

In an embodiment, each client domain includes a client and SystemC intellectual property models, the client is used to communicate with the controller domain.

### BRIEF DESCRIPTION OF THE DRAWINGS

FIG. 1 is a flowchart of a multi-processing accelerating method based on an electronic-system-level virtual platform according to an embodiment of the present disclosure.

FIG. 2 is a schematic structural diagram of an electronic-system-level virtual platform according to an embodiment of the present disclosure.

FIG. 3 is a schematic diagram illustrating how multiple client domains communicate with each other according to an embodiment of the present disclosure.

FIG. 4 is a schematic structural diagram of a multi-processing accelerating system based on an electronic-system-level virtual platform according to an embodiment of the present disclosure.

### DETAILED DESCRIPTION

The following describes embodiments of the present disclosure by using specific embodiments. A person skilled in the art may easily understand other advantages and effects of the present disclosure from the content disclosed in this specification. The present disclosure may also be implemented or applied through different specific embodiments. Various details in this specification may also be modified or changed based on different viewpoints and applications without departing from the spirit of the present disclosure. It should be noted that the embodiments below and features in the embodiments can be combined with each other in the case of no conflict.

It should be noted that, the drawings provided in the following embodiments only exemplify the basic idea of the present disclosure. Therefore, only the components related to the present disclosure are shown in the drawings, and are not drawn according to the quantity, shape, and size of the components during actual implementation. During actual implementation, the type, quantity, and proportion of the components may be changed, and the layout of the components may be more complex.

The present disclosure provides a multi-processing accelerating method and a multi-processing accelerating system based on an electronic-system-level (ESL) virtual platform. Without modifying the SystemC kernels and the existing model codes, the parallelization of computationally intensive models is realized, which can effectively accelerate the operation of the ESL virtual platform and improve the efficiency of software development of the ESL virtual platform.

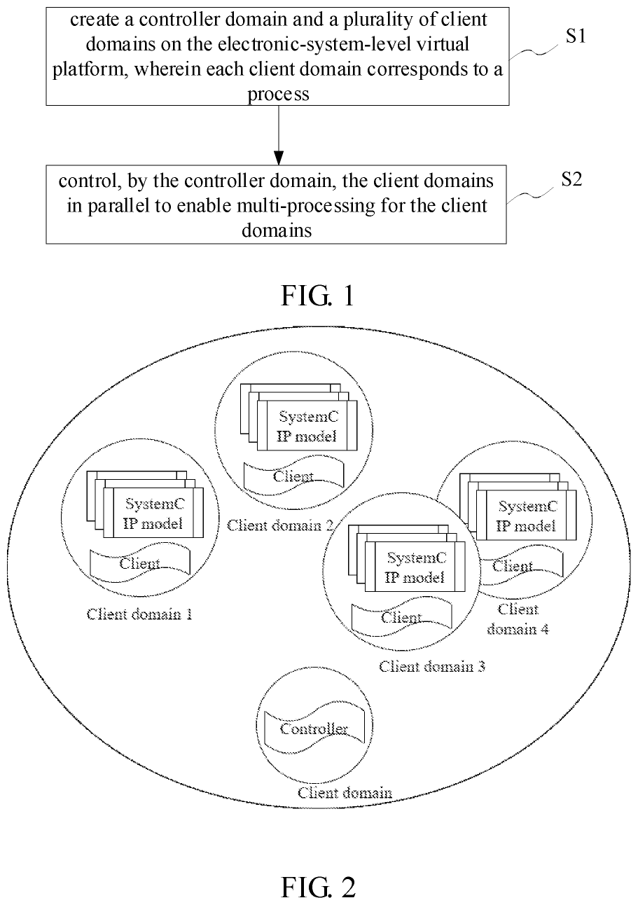

In an embodiment, as shown in FIG. 1, the multi-processing accelerating method for the ESL virtual platform includes the following steps:

In step S1, creating a controller domain and a plurality of client domains on the electronic-system-level virtual platform, where each client domain corresponds to a process.

For example, as shown in FIG. 2, the controller domain (e.g., domain 0) and multiple client domains (e.g., domain 1, domain 2, domain 3, domain 4) are created on the ESL virtual platform.

Each client domain corresponds to a process. Each client domain includes a client and SystemC intellectual property (IP) models. Each client is used to communicate with the controller domain. In an embodiment, each client is connected to the controller domain, is used to log, assign and bind local initiator sockets or local target sockets, is used to log, assign and bind remote initiator sockets or remote target sockets, is used to receive or send a barrier message from the controller domain and an end message from the controller domain, is used to send and receive loads, and is used to start the SystemC kernels during a process.

The controller domain is a control center, which is used to coordinate the client domains to achieve cooperation among multiple processes. In an embodiment, specifically, the controller domain is used for the registration of the client domains, the registration or query of the client domain proxy sockets, the execution of barrier operations and end operations, and so on.

In step S2, controlling, by the controller domain, the client domains in parallel to enable multi-processing for the client domains.

In an embodiment, the controller domain is communicated with each client domain through a corresponding unix domain socket (UDS), which provides better latency than other local inter-process communications (IPC).

Under the control of the controller domain, communication connections are established among the client domains to achieve multi-processing.

In an embodiment, steps of establishing communication connections among the client domains are as follows:

In step 110, during initialization, parsing, by the controller domain, a configuration file to determine the SystemC IP modules included in each client domain, starting a unix domain socket server, and waiting for the client domains to connect to the unit domain socket server.

In step 120, during modularization, instantiating, by each client domain, its own instances of SystemC IP modules and recording its own initiator transaction-level-modeling (TLM) sockets or its own target TLM sockets. During modularization, the controller domain does not operate.

In step 130, during start-up, creating, by each client domain, its own remote initiator sockets or its own remote target sockets, and establishing connections among the client domains based on a confirmation message from the controller domain; and starting, by each client domain, its own SystemC kernels when all the client domains receive a barrier message from the controller domain.

In an embodiment, each client domain creates its own remote initiator sockets or its own remote target sockets, and sends a corresponding query message or a corresponding registration message to the controller domain. Target connections among the client domains are established through a confirmation message (e.g., an acknowledgement message) from the controller domain. Thereafter, the client domains may bind the proxy initiator sockets or the proxy target sockets to the initiator sockets or the target sockets; for example, the proxy initiator TLM sockets are bound to the initiator TLM sockets, and the proxy target TLM sockets are bound to the target TLM sockets, and the proxy initiators are remotely connected to the proxy targets. When all the client domains receive the barrier message from the controller domain, the client domains call a function (e.g., sc_kemel::sc_start( )) to start their respective SystemC kernels.

In step 140, during operation, when any client domain transmits an end message to the controller domain, broadcasting, by the controller domain, the end message to the other client domains to stop the operation of all the client domains and end the operation of the controller domain.

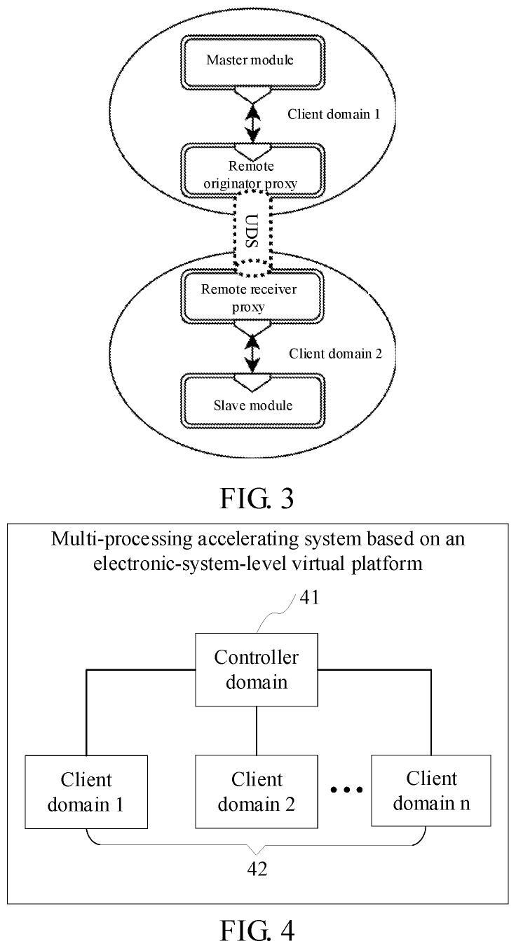

As shown in FIG. 3, the client domains are communicated with each other through a corresponding unix domain socket. As in step 130 above, after connections are established among the client domains, the client domains may be communicated with each other as follows:

In step 131, setting two of the client domains communicated with each other to be a master module domain and a slave module domain respectively. The master module domain includes a master module and a remote initiator proxy, and the slave module domain includes a slave module and a remote target proxy. In an embodiment, the master module and the salve module are implemented by the SystemC IP models of corresponding client domains respectively, and the remote initiator proxy and the remote target proxy are implemented by client instances of corresponding client domains respectively. In an embodiment, the remote initiator proxy and the remote target proxy are implemented by function modules in the corresponding client instances.

In an embodiment, the initiator remote initiator proxy provides TLM binding completeness in the master module domain, provides methods for encoding and serializing TLM transactions and for sending UDS messages to the remote target proxy connected thereto, supports a direct memory interface (DMI), and so on.

In an embodiment, the remote target proxy provides TLM binding completeness in the salve module domain, provides methods for receiving, deserializing and decoding TLM transactions, supports the DMI interface and a resident routine for receiving the UDS messages from the initiator remote initiator proxy connected to the remote target proxy.

In step 132, encoding and serializing, by the master model, TLM messages into messages in a predefined message format, and transmitting the messages in the predefined message format to the remote initiator proxy through the UDS.

In an embodiment, the predefined message format is the “protobuf” message format.

In step 133, transmitting, by the remote initiator proxy, the messages in the predefined message format to the remote target proxy through a corresponding unix domain socket.

In step 134, deserializing and decoding, by the remote target proxy, the messages in the predefined message format to obtain the TLM messages, and transmitting the TLM messages to the slave module.

In step 135, receiving, by the slave module, the TLM messages.

In an embodiment, when running the scripts, a binary file of a compiled ESL virtual platform is run for multiple times, and the binary file is bound to a specified process each time the binary file is run. Each client domain or each progress may be linked to its own SystemC library. The SystemC IP models of each client domain may directly instantiate its own previous single-threaded virtual platform, or are formed in a multi-processing virtual platform framework.

In an embodiment, as shown in FIG. 4, the present disclosure provides a multi-processing accelerating system for an electronic-system-level virtual platform. The multi-processing accelerating system includes a plurality of client domains 42 and a controller domain 41, which are created on the electronic-system-level virtual platform.

For example, as shown in FIG. 2, the controller domain (e.g., domain 0) and multiple client domains (e.g., domain 1, domain 2, domain 3, domain 4) are created on the electronic-system-level virtual platform.

Each client domain corresponds to a progress. Each client domain includes a client and SystemC IP models. Each client is used to communicate with the controller domain. In an embodiment, each client is connected to the controller domain, is used to log, assign and bind local initiator sockets or local target sockets, is used to log, assign and bind of remote initiator sockets or remote target sockets, is used to receive or send a barrier message from the controller domain and an end message from the controller domain, is used to send and receive loads, and is used to start the SystemC kernels in the process.

The controller domain is a control center, which is used to coordinate the client domains to achieve cooperation among multiple processes. In an embodiment, the controller domain is used for the registration of the client domains, the registration or query of the client domain proxy sockets, the execution of barrier operations and the execution of end operations, and so on.

In an embodiment, the controller domain is communicated with each client domain through a UDS, which provides better latency than other local IPC.

Under the control of the controller domain, communication connections are established among the client domains to achieve multi-processing.

In step 110, during initialization, parsing, by the controller domain, a configuration file to determine the SystemC IP modules included in each client domain, starting a UDS server, and waiting for the client domains to connect to the UDS server.

In step 120, during modularization, instantiating, by each client domain, its own instances SystemC IP modules and recording its own initiator TLM sockets or its own target TLM sockets. During modularization, the controller domain does not operate.

In step 130, during start-up, creating, by each client domain, its own remote initiator sockets or its own remote target sockets, and establishing connections among the client domains based on a confirmation message from the controller domain; and starting, by each client domain, its own SystemC kernels when all the client domains receive a barrier message from the controller domain.

In an embodiment, each client domain creates its own remote initiator sockets or its own remote target sockets, and sends a corresponding query message or a corresponding registration message to the controller domain. Target connections among the client domains are established through a confirmation message (e.g., an acknowledgement message) from the controller domain. Thereafter, the client domains may bind the proxy initiator sockets or the proxy target sockets to the initiator sockets or the target sockets; for example, the proxy initiator TLM sockets are bound to the initiator TLM sockets, and the proxy target TLM sockets are bound to the target TLM sockets, and the proxy originators are remotely connected to the proxy receivers. When all the client domains receive the barrier message of the controller domain, the client domains call a function (e.g., sc_kemel::sc_start( ) to start their respective SystemC kernels.

In step 140, during operation, when any client domain transmits an end message to the controller domain, broadcasting, by the controller domain, the end message to the other client domains to stop the operation of all the client domains and end the operation of the controller domain itself.

As shown in FIG. 3, the client domains are communicated with each other through a corresponding UDS. As in step 130 above, after connections are established among the client domains, the client domains may be communicated with each other as follows:

In step 131, setting two of the client domains communicated with each other to be a master module domain and a slave module domain respectively. The master module domain includes a master module and a remote initiator proxy, and the slave module domain includes a slave module and a remote target proxy. In an embodiment, the master module and the salve module are implemented by the SystemC IP models of corresponding client domains respectively, and the remote initiator proxy and the remote target proxy are implemented by client instances of corresponding client domains respectively. In an embodiment, the remote initiator proxy and the remote target proxy are implemented by function modules in the corresponding client instances.

In an embodiment, the initiator remote initiator proxy provides TLM binding completeness in the master module domain, provides methods for encoding and serializing TLM transactions and for sending UDS messages to the remote target proxy connected thereto, supports a DMI, and so on.

In an embodiment, the remote target proxy provides TLM binding completeness in the salve module domain, provides methods for receiving, deserializing and decoding TLM transactions, supports an interface, and a resident routine for receiving the UDS messages from the initiator remote initiator proxy connected to the remote target proxy.

In step 132, encoding and serializing, by the master model, TLM messages into messages in a predefined message format, and transmitting the messages in the predefined message format to the remote initiator proxy through the UDS.

In an embodiment, the predefined message format is the “protobuf” message format.

In step 133, transmitting, by the remote initiator proxy, the messages in the predefined message format to the remote target proxy through a corresponding UDS.

In step 134, deserializing and decoding, by the remote target proxy, the messages in the predefined message format to obtain the TLM messages, and transmitting the TLM messages to the slave module.

In step 135, receiving, by the slave module, the TLM messages.

In an embodiment, when running the scripts, a binary file of a compiled ESL virtual platform is run multiple times, and the binary file is bound to a specified process each time the binary file is run. Each client domain or each progress may be linked to its own SystemC library. The SystemC IP models of each client domain may directly instantiate its own previous single-threaded virtual platform, or are formed in a multi-process virtual platform framework.

As described above, without modifying the SystemC kernels and the existing model codes, the multi-processing accelerating system and the multi-processing accelerating method based on the electronic-system-level virtual platform are provided. Only some intermediate layers are inserted to proxy the interaction among modules of the SystemC kernels and the existing model codes to achieve parallelization of computationally intensive modules, thereby effectively accelerating the operation of ESL virtual platform, improving the efficiency of software development of the ESL virtual platform, obtaining a linear acceleration ratio under computationally intensive loads. The adopted transaction-level-modeling over multi-processes (TLMMP) method is applicable to the simulation of an asymmetric multiprocessing (AMP) central processing unit (CPU) architecture and the simulation of computationally intensive IP modules with less interaction among them. Therefore, this application has a high industrial utilization value.

The above-mentioned embodiments are just used for exemplarily describing the principle and effects of the present disclosure instead of limiting the present disclosure. Changes and variations made by those skilled in the art without departing from the spirit and scope of the present disclosure fall within the scope of the present disclosure.

What is claimed is:

1. A multi-processing accelerating method based on an electronic-system-level virtual platform, comprising:
creating a controller domain and a plurality of client domains on the electronic-system-level virtual platform, wherein each client domain corresponds to a process; and
controlling, by the controller domain, the client domains in parallel to enable multi-processing for the client domains.

2. The multi-processing accelerating method based on the electronic-system-level virtual platform according to claim 1, wherein each client domain comprises a client and SystemC intellectual property models, each client is used to communicate with the controller domain.

3. The multi-processing accelerating method based on the electronic-system-level virtual platform according to claim 1, wherein the controller domain is communicated with each client domain through a corresponding unix domain socket.

4. The multi-processing accelerating method based on the electronic-system-level virtual platform according to claim 1, wherein the client domains are communicated with each other through a corresponding unix domain socket.

5. The multi-processing accelerating method based on the electronic-system-level virtual platform according to claim 1, steps where the client domains are communicated with each other through a corresponding unix domain socket comprise:
setting two of the client domains communicated with each other to be a master module domain and a slave module domain respectively, wherein the master module domain comprises a master module and a remote initiator proxy, and the slave module domain comprises a slave module and a remote target proxy;
encoding and serializing, by the master model, transaction-level-modeling (TLM) messages into messages in a predefined message format, and transmitting the messages in the predefined message format to the remote initiator proxy;
transmitting, by the remote initiator proxy, the messages in the predefined message format to the remote target proxy through a corresponding unix domain socket;
deserializing and decoding, by the remote target proxy, the messages in the predefined message format to obtain the TLM messages, and transmitting the TLM messages to the slave module; and
receiving, by the slave module, the TLM messages.

6. The multi-processing accelerating method based on the electronic-system-level virtual platform according to claim 5, wherein the master module and the salve module are implemented by SystemC intellectual property models of corresponding client domains respectively, and the remote initiator proxy and the remote target proxy are implemented by client instances of corresponding client domains respectively.

7. The multi-processing accelerating method based on the electronic-system-level virtual platform according to claim 1, the step of controlling the client domains in parallel to enable multi-processing for the client domains comprises:
during initialization, parsing, by the controller domain, a configuration file to determine SystemC intellectual property modules included in each client domain, starting a unix domain socket server, and waiting for the client domains to connect to the unix domain socket server;
during modularization, instantiating, by each client domain, its own instances of SystemC intellectual property modules and recording its own TLM sockets or its own target TLM sockets;
during start-up, creating, by each client domain, its own remote initiator sockets or its own remote target sockets, and establishing connections among the client domains based on a confirmation message from the controller domain; and starting, by each client domain, its own SystemC kernels when all the client domains receive a barrier message from the controller domain; and
during operation, when any client domain transmits an end message to the controller domain, broadcasting, by the controller domain, the end message to the other client domains to stop the operation of all the client domains and end the operation of the controller domain.

8. A multi-processing accelerating system based on an electronic-system-level virtual platform, the multi-processing accelerating system comprising:
a plurality of client domains, created on the electronic-system-level virtual platform, wherein each client domain corresponds to a process; and
a controller domain, created on the electronic-system-level virtual platform, used to control the client domains in parallel to enable multi-processing for the client domains.

9. The multi-processing accelerating system based on the electronic-system-level virtual platform according to claim 8, wherein each client domain comprises a client and SystemC intellectual property models, the client is used to communicate with the controller domain.

10. The multi-processing accelerating system based on the electronic-system-level virtual platform according to claim 8, wherein the controller domain is communicated with each client domain through a corresponding unix domain socket.

11. The multi-processing accelerating system based on the electronic-system-level virtual platform according to claim 8, wherein the client domains are communicated with each other through a corresponding unix domain socket.

12. The multi-processing accelerating system based on the electronic-system-level virtual platform according to claim 11, wherein the client domains are communicated with each other through a corresponding unix domain socket, comprises:
setting two of the client domains communicated with each other to be a master module domain and a slave module domain respectively, wherein the master module domain comprises a master module and a remote initiator proxy, and the slave module domain comprises a slave module and a remote target proxy;
encoding and serializing, by the master model, transaction level modeling (TLM) messages into messages in a predefined message format, and transmitting the messages in the predefined message format to the remote initiator proxy;
transmitting, by the remote initiator proxy, the messages in the predefined message format to the remote target proxy through a corresponding unix domain socket;
deserializing and decoding, by the remote target proxy, the messages in the predefined message format to obtain the TLM messages, and transmitting the TLM messages to the slave module; and
receiving, by the slave module, the TLM messages.

13. The multi-processing accelerating system based on the electronic-system-level virtual platform according to claim 12, wherein the master module and the salve module are implemented by SystemC intellectual property models of corresponding client domains respectively, and the remote initiator proxy and the remote target proxy are implemented by client instances of corresponding client domains respectively.

14. The multi-processing accelerating system based on the electronic-system-level virtual platform according to claim 8, steps of controlling the client domains in parallel to enable multi-processing for the client domains comprise:
during initialization, parsing, by the controller domain, a configuration file to determine SystemC intellectual property modules included in each client domain, starting a unix domain socket server, and waiting for the client domains to connect to the unix domain socket server;
during modularization, instantiating, by each client domain, its own instances of SystemC intellectual property modules and recording its own initiator TLMsockets or its own target TLM sockets;
during start-up, creating, by each client domain, its own remote initiator sockets or its own remote target sockets, and establishing connections among the client domains based on a confirmation message from the controller domain; and starting, by each client domain, its own SystemC kernels when all the client domains receive a barrier message from the controller domain; and
during operation, when any client domain transmits an end message to the controller domain, broadcasting, by the controller domain, the end message to the other client domains to stop the operation of all the client domains and end the operation of the controller domain.
